(19) United States
(12) Patent Application Publication
(10) Pub. No.: US 2005/0266164 A1
(43) Pub. Date: Dec. 1, 2005

(54) Method of making a vane with a grainy pattern for a fan

(76) Inventor: Yu-Keng Huang, Tucheng City (TW)

Correspondence Address: Yu-Keng Huang, P.O. Box No. 6-57, Junghe, Taipei, 235, TW

(21) Appl. No.: 10/856,955

(22) Filed: Jun. 1, 2004

(51) Int. Cl. B05D 5/00

(52) U.S. Cl. 427/256

(57) ABSTRACT

A method of making a vane with a grainy pattern for a fan includes an extrusion forming step, a cutting step, a thermal transfer step, a painting step and a drying step. A board made from foamed plastics is formed through an extrusion forming machine and formed at the extrusion forming step is cut to form a rudimental plate through a punch. The rudimental plate is put on a moving device of a thermal transfer machine for carrying the rudimental plate to pass through a heated PU roller, thereby printing the grainy pattern of the thermal transfer ribbon on the surface of the rudimental plate. UV clear lacquer is painted on the surface of the rudimental plate to cover the grainy pattern through a PU roller of the painting equipment. Through ultraviolet desiccating treatment thereby connecting the UV clear lacquer layer and the grainy pattern layer together.

### BACKGROUND OF THE INVENTION

a) Field of the Invention

The present invention relates to a method of making a vane with a grainy pattern for a fan, and particularly to a method which includes an extrusion forming step, a cutting step, a thermal transfer step, a painting step and a drying step for making a vane with a grainy pattern for a fan.

b) Description of the Prior Art

In general, a current design style of a furniture is to show a high-grade furniture through a natural grain of wood. Except that a furniture made of logs shows the grain of wood, a furniture of which outer surfaces are covered with a wooden decoration also shows the grain of wood thereby increasing real sense of the furniture. The wooden decoration is made from logs through cutting the logs to be slices. Of cause, the logs come from trees.

However, since the speed of felling trees are higher than the speed of planting trees, the wooden decorations should be reduced for environment protection.

Furthermore, since the wooden decoration is frangible, the wooden decoration cannot be applied to a vane with a relatively large curve. Moreover, it is manual work to attach the wooden decoration to a surface of the vane, which results in low efficiency and high cost.

### SUMMARY OF THE INVENTION

Accordingly, an object of the present invention is to provide a method of making a vane with a grainy pattern for a fan thereby efficiently making the vane and reducing the cost.

To achieve the above-mentioned object, a method of making a vane with a grainy pattern for a fan in accordance with the present invention includes an extrusion forming step, a cutting step, a thermal transfer step, a painting step and a drying step. In the extrusion forming step, forming a board made from foamed plastics through an extrusion forming machine. In the cutting step, cutting the board formed at the extrusion forming step to form a rudimental plate through a punch. In the thermal transfer step, putting the rudimental plate on a moving device of a thermal transfer machine for carrying the rudimental plate to pass through a heated PU roller, and pressing a thermal transfer ribbon with a grainy pattern against a surface of the rudimental plate through the heated PU roller, thereby printing the grainy pattern of the thermal transfer ribbon on the surface of the rudimental plate. In the painting step, transmitting the rudimental plate with the grainy pattern thereon to a painting equipment, and painting UV clear lacquer on the surface of the rudimental plate to cover the grainy pattern through a PU roller of the painting equipment. In the drying step, transmitting the rudimental plate with the UV clear lacquer to a drying equipment and drying the UV clear lacquer of the rudimental plate through ultraviolet desiccating treatment thereby connecting the UV clear lacquer layer and the grainy pattern layer together.

Wherein in the extrusion step, a thickness of the board is between 3 mm˜6 mm.

Wherein the moving device is a traveling transfer platform.

Wherein the PU roller is heated with a temperature between 180° C.˜220° C.

Wherein the UV clear lacquer is painted on the surface of the rudimental plate at a temperature of 25° C. and the thickness of the UV clear lacquer is about 0.4 mm˜0.6 mm.

Wherein in the drying equipment, a lamp which produces ultraviolet through pressure mercury vapor irradiates the rudimental plate with a distance of 20 cm therebetween, a temperature inside the drying equipment is controlled between 60° C.˜80° C., and the surface temperature of the rudimental plate is maintained at 35° C.

Wherein the moving device is a conveyer belt.

Wherein the foamed plastics is selected from ABS (Acrylonitrile Butadiene Styrene), PVC (PolyVinyl Chloride) or the like.

Other objects, advantages and novel features of the present invention will be drawn from the following detailed embodiments of the present invention with attached drawings, in which:

### BRIEF DESCRIPTION OF THE DRAWINGS

FIG. 1 is a flowchart of a method of making a vane with a grainy pattern for a fan of the present invention;

FIG. 2 is a schematic view of a thermal transfer step of the method of making a vane with a grainy pattern for a fan;

FIG. 3 is a schematic view of a painting step of the method of making a vane with a grainy pattern for a fan;

FIG. 4 is a schematic view of a drying step of the method of making a vane with a grainy pattern for a fan;

FIG. 5 is a schematic view of an alternative thermal transfer step of a method of making a vane with a grainy pattern for a fan of the present invention.

### DETAILED DESCRIPTION OF THE PREFERRED EMBODIMENTS

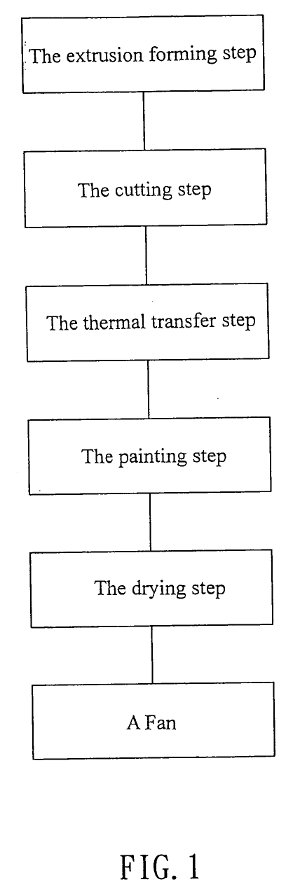

Referring to FIG. 1, a method of making a vane with a grainy pattern for a fan of the present invention includes an extrusion forming step, a cutting step, a thermal transfer step, a painting step and a drying step thereby forming a grainy pattern of a thermal transfer ribbon on a surface of the vane for the fan. The steps are respectively described as follows.

(a) The Extrusion Forming Step

Forming a board made from foamed plastics such as ABS (Acrylonitrile Butadiene Styrene) or PVC (PolyVinyl Chloride) through an extrusion forming machine. The board is light and strong with a thickness between 3 mm˜6 mm. In the extrusion forming step, the viscosity and fluidity of the foamed plastics, the sprue configuration for a mould and related technical parameters are the key points.

(b) The Cutting Step

Cutting the board formed at the extrusion forming step to form a rudimental plate 10 through a punch.

(c) The Thermal Transfer Step

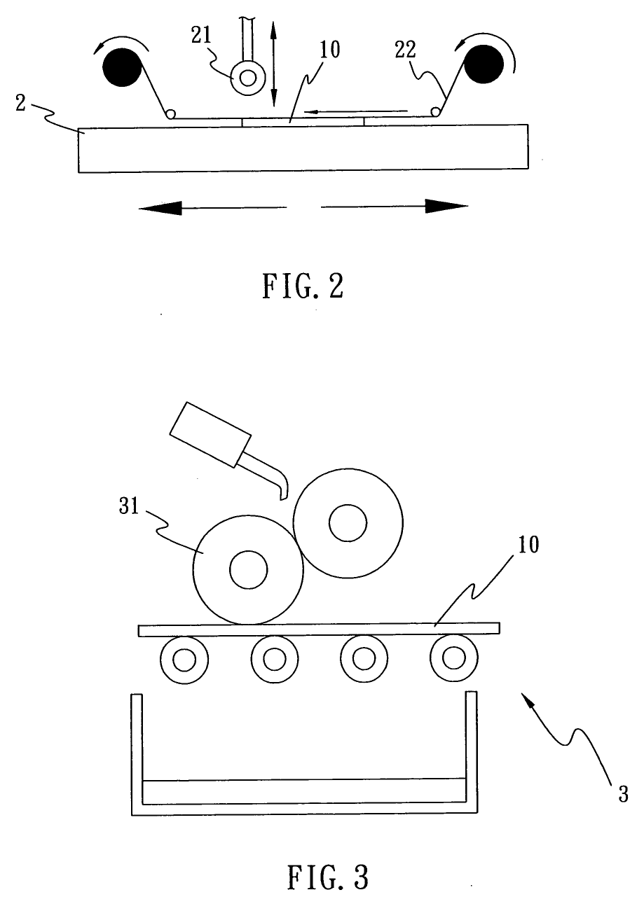

As shown in FIG. 2, putting the rudimental plate 10 on a traveling transfer platform 2 of a thermal transfer machine for carrying the rudimental plate 10 to pass through a PU roller 21 above the rudimental plate 10, and pressing a thermal transfer ribbon 22 with a grainy pattern against a surface of the rudimental plate 10 through the PU roller 21 which is heated with a temperature between 180° C.˜220° C., thereby printing the grainy pattern of the thermal transfer ribbon 22 on the surface of the rudimental plate 10.

(d) The Painting Step

As shown in FIG. 3, transmitting the rudimental plate 10 with the grainy pattern thereon to a painting equipment 3; and painting UV clear lacquer on the surface of the rudimental plate to cover the grainy pattern at a temperature of 25° C. through a PU roller 31 of the painting equipment 3. The thickness of the UV clear lacquer is about 0.4 mm˜0.6 mm.

(e) The Drying Step

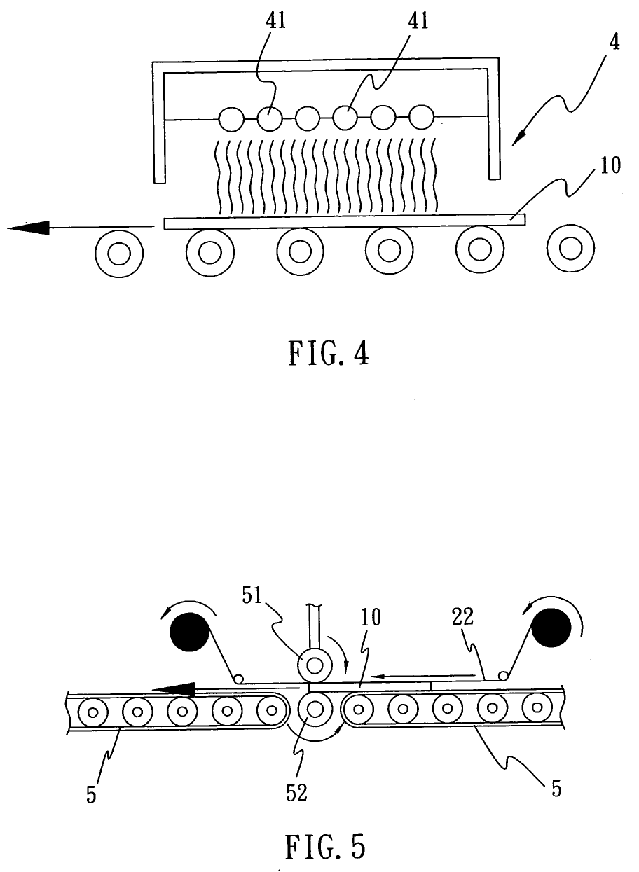

As shown in FIG. 4, transmitting the rudimental plate 10 with the UV clear lacquer to a drying equipment 4 and drying the UV clear lacquer of the rudimental plate 10 through ultraviolet desiccating treatment thereby connecting the UV clear lacquer layer and the grainy pattern layer together. In the drying equipment 4, a lamp 41 which produces ultraviolet through pressure mercury vapor irradiates the rudimental plate 10 with a distance of 20cm therebetween. A temperature inside the drying equipment 4 is controlled between 60° C.˜80° C. The surface temperature of the rudimental plate 10 is maintained at 35° C. Thus, the UV lacquer layer of the rudimental plate 10 is quickly dried and hardened.

Through the above-mentioned steps, the rudimental plate 10 is readily made to be a vane with a grainy pattern for a fan. The vane not only is light and strong, but also has a grainy pattern which makes the vane look as if made of a log. Thus, the vane is made efficiently and the cost of the vane is reduced.

As shown in FIG. 5, an alternative thermal transfer step is shown. In the alternative thermal step, putting the rudimental plate 10 on a conveyer belt 5 of a thermal transfer machine for carrying the rudimental plate 10 to pass through a pair of upper and lower PU rollers 51, 52 at opposite sides of the rudimental plate 10, and pressing a thermal transfer ribbon 22 with a grainy pattern against a surface of the rudimental plate 10 through the lower roller 52 and the upper PU roller 51 which is heated with a temperature between 180° C.˜220° C., thereby printing the grainy pattern of the thermal transfer ribbon 22 on the surface of the rudimental plate 10.

Furthermore, after the cutting step, a cold roll step may be applied to the rudimental plate 10 for maintaining the shape of the rudimental plate 10 thereby preventing the rudimental plate 10 from deformation.

It is understood that the invention may be embodied in other forms without departing from the spirit thereof. Thus, the present examples and embodiments are to be considered in all respects as illustrative and not restrictive, and the invention is not to be limited to the details given herein.

1. A method of making a vane with a grainy pattern for a fan, comprising the following steps:
(a) an extrusion forming step
forming a board made from foamed plastics through an extrusion forming machine;
(b) a cutting step
cutting the board formed at the extrusion forming step to form a rudimental plate through a punch;
(c) a thermal transfer step
putting the rudimental plate on a moving device of a thermal transfer machine for carrying the rudimental plate to pass through a heated PU roller, and pressing a thermal transfer ribbon with a grainy pattern against a surface of the rudimental plate through the heated PU roller, thereby printing the grainy pattern of the thermal transfer ribbon on the surface of the rudimental plate;
(d) a painting step
transmitting the rudimental plate with the grainy pattern thereon to a painting equipment, and painting UV clear lacquer on the surface of the rudimental plate to cover the grainy pattern through a PU roller of the painting equipment;
(e) a drying step
transmitting the rudimental plate with the UV clear lacquer to a drying equipment and drying the UV clear lacquer of the rudimental plate through ultraviolet desiccating treatment thereby connecting the UV clear lacquer layer and the grainy pattern layer together.

2. The method of making a vane with a grainy pattern for a fan as claimed in claim 1, wherein in the extrusion step, a thickness of the board is between 3 mm˜6 mm.

3. The method of making a vane with a grainy pattern for a fan as claimed in claim 1, wherein the moving device is a traveling transfer platform.

4. The method of making a vane with a grainy pattern for a fan as claimed in claim 1, wherein the PU roller is heated with a temperature between 180° C.˜220° C.

5. The method of making a vane with a grainy pattern for a fan as claimed in claim 1, wherein the UV clear lacquer is painted on the surface of the rudimental plate at a temperature of 25° C. and the thickness of the UV clear lacquer is about 0.4 mm˜0.6 mm.

6. The method of making a vane with a grainy pattern for a fan as claimed in claim 1, wherein in the drying equipment, a lamp which produces ultraviolet through pressure mercury vapor irradiates the rudimental plate with a distance of 20 cm therebetween, a temperature inside the drying equipment is controlled between 60° C.˜80° C., and the surface temperature of the rudimental plate is maintained at 35° C.

7. The method of making a vane with a grainy pattern for a fan as claimed in claim 1, wherein the moving device is a conveyer belt.

8. The method of making a vane with a grainy pattern for a fan as claimed in claim 1, wherein the foamed plastics is selected from ABS (Acrylonitrile Butadiene Styrene), PVC (PolyVinyl Chloride) or the like.
